(19) United States
(12) Patent Application Publication
(10) Pub. No.: US 2026/0147736 A1
(43) Pub. Date: May 28, 2026

(54) CLOUD BASED RELEVANT INFORMATION CURATION OF HETEROGENEOUS REDFISH API IMPLEMENTATIONS

(71) Applicant: American Megatrends International, LLC, Duluth, GA (US)

(72) Inventors: CHITRAK GUPTA, Johns Creek, GA (US); Hari Venkatachalam, Bengaluru (IN)

(21) Appl. No.: 18/956,880

(22) Filed: Nov. 22, 2024

(51) Int. Cl. G06F 16/215; G06F 16/9532

(52) U.S. Cl. CPC G06F 16/215; G06F 16/9532

(57) ABSTRACT

In an aspect of the disclosure, a method, a computer-readable medium, and an apparatus are provided. The apparatus may be a computing device. The computing device initiates discovery of Redfish-capable nodes in a data center. The computing device performs a Redfish tree walk for each discovered node to collect resource information. The computing device parses the collected resource information to generate cleaned data by removing non-essential data. The computing device stores the cleaned data in a database. The computing device provides a query interface for accessing resources across the data center using keyword-based searches.

### BACKGROUND

### Field

The present disclosure relates generally to computing systems, and more particularly, to techniques of curating and managing resource information from heterogeneous servers in data center environments.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v. 2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Data center management has traditionally relied on various protocols and standards to monitor and control server hardware and resources. The DMTF (Distributed Management Task Force) Redfish specification emerged as a modern standard designed to simplify server and storage management through a RESTful interface, providing a standardized way to manage hardware in data centers. This specification defines a common schema for representing server components, sensors, and other manageable resources.

Before the introduction of Redfish, data centers typically used protocols like IPMI (Intelligent Platform Management Interface) or vendor-specific management interfaces, which often lacked consistency across different hardware manufacturers. Redfish addressed many limitations of these earlier protocols by providing a more modern, secure, and standardized approach. However, while Redfish established a common foundation, it deliberately maintained flexibility in implementation details to accommodate various vendor requirements and use cases.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is a computing device. The computing device initiates discovery of Redfish-capable nodes in a data center. The computing device performs a Redfish tree walk for each discovered node to collect resource information. The computing device parses the collected resource information to generate cleaned data by removing non-essential data. The computing device stores the cleaned data in a database. The computing device provides a query interface for accessing resources across the data center using keyword-based searches.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a cloud-based system for curating and managing information from heterogeneous Redfish API implementations in a data center environment.

FIG. 3 is a block diagram illustrating the key components and data flows in an intelligent URL mapping and search system designed to manage and curate information from heterogeneous Redfish API implementations in a data center environment.

FIG. 4 is a flowchart illustrating a process for discovering, collecting, and managing resource information in a heterogeneous data center environment using an intelligent URL mapping system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

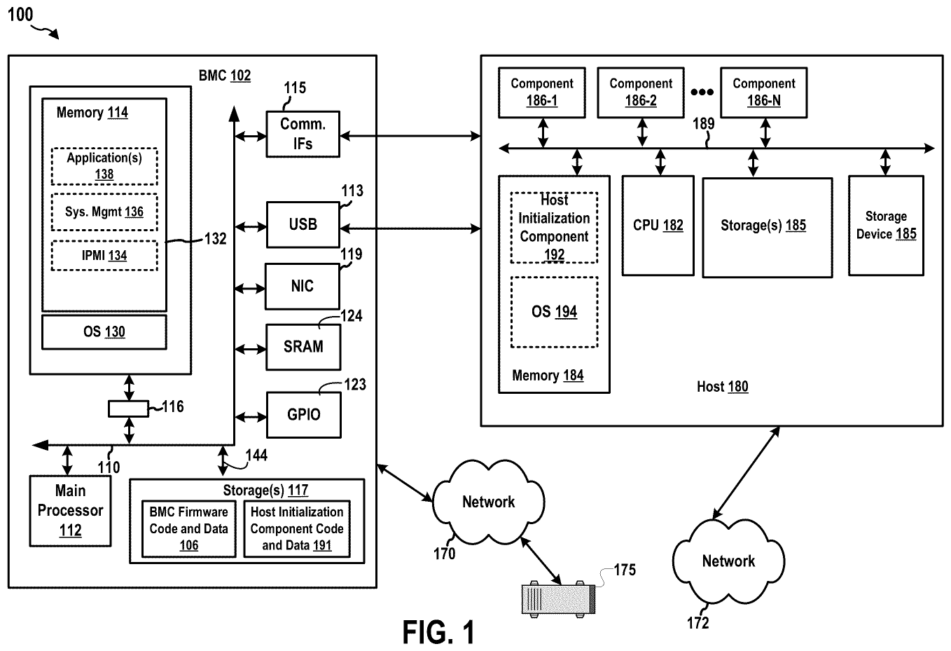

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

The BMC firmware code and data 106 and the host initialization component code and data 191 stored in the storage(s) 117 may contain sensitive information such as authentication keys, user information, and host information. Unauthorized access to this sensitive information could compromise the security of the server. Typically, server administrators implement security measures to restrict access to this sensitive data.

However, when a server is decommissioned, the storage devices may be removed or data may be erased without proper precautions. The flash memory chips containing the BMC firmware code and data 106 and the host initialization component code and data 191 are often overlooked during decommissioning. An attacker with physical access to these discarded flash memory chips can easily extract the sensitive data.

Recently, source code for many BMC and BIOS firmware has been open sourced (e.g., Open BMC and Open UEFI). This allows attackers to more easily decode the extracted firmware images. For ease of administration, servers within a datacenter often use identical BMC and BIOS firmware. Thus, compromised firmware from one discarded server could expose all servers in that datacenter.

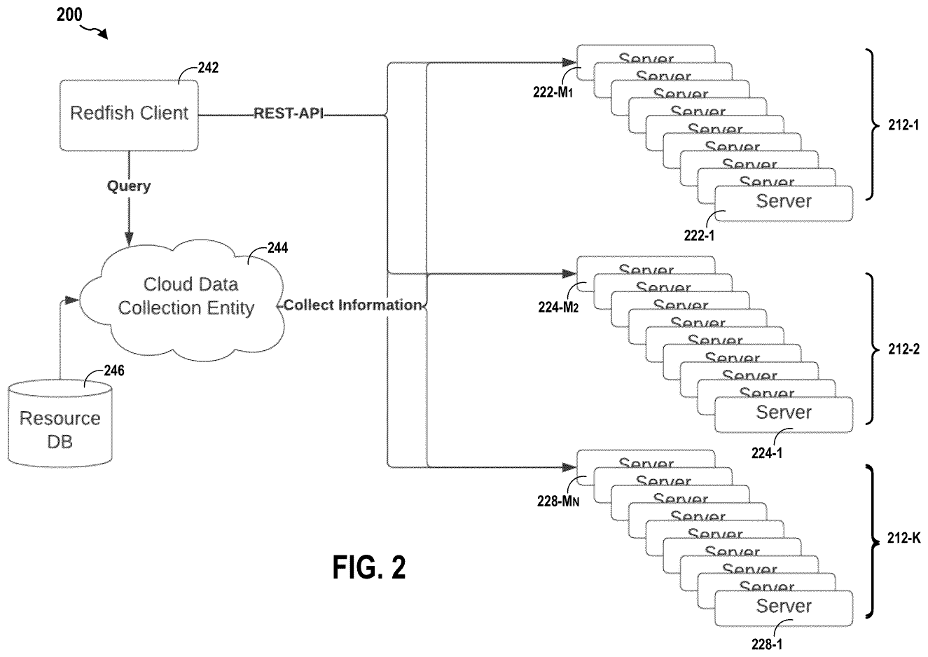

FIG. 2 is a diagram 200 illustrating a cloud-based system for curating and managing information from heterogeneous Redfish API implementations in a data center environment. In this example, a heterogeneous data center 202 includes multiple racks of servers 212-1, 212-2, . . . , 212-K, each containing one or more servers. For example, the rack 212-1 includes servers 222-1, 222-2, . . . , 222-M₁. The rack 212-2 includes servers 224-1, 224-2, . . . , 224-M₂, and so on. The rack 212-K includes servers 228-1, 228-2, . . . , 228-M_{K}.

The servers in the heterogeneous data center 202 implement the DMTF Redfish specification, which provides a standard schema for managing system devices. The Redfish specification defines a set of standard schemas that describe the properties and data types of various system devices, along with interfaces that enable management and monitoring operations on these devices.

However, the Redfish specification also allows for customization through OEM (Original Equipment Manufacturer) sections, enabling implementers to enhance the standard schema by adding proprietary resources and information to the Redfish output. This flexibility in enhancing the schema results in variations in the representation of similar resources across different implementations.

Furthermore, the Redfish specification does not impose restrictions on naming conventions for resources, leaving it to the implementers to assign names as they see fit. For example, a temperature sensor in one implementation might be named “CPU1Temp,” while in another implementation it might be named “TempSensor1.” This lack of uniformity in naming conventions makes it difficult to accurately identify and access resources without detailed knowledge of each implementation's specific schema.

Additionally, the URL structures used to access these resources can vary significantly between implementations. For instance, one implementation might define the URL for accessing a temperature sensor as /redfish/v1/Chassis/<ID>/Sensors/Temperatures/<ID>, while another implementation might use /redfish/v1/Chassis/Self/Sensors/101. This divergence in URL definitions further complicates the process of locating and accessing resources within the data center.

In a first technical scheme, accessing specific resources within the heterogeneous data center 202 requires initiating from a root node and traversing the hierarchical structure defined by each server's Redfish implementation. This process necessitates executing multiple API requests and parsing numerous responses to navigate through the various layers of the Redfish schema until reaching the desired resource. For example, to locate temperature sensors across the servers 222-1 to 222-M₁ in the rack 212-1, an application must navigate through the chassis, thermal zones, and sensor collections, which might be differently structured or named in each server due to customizations and OEM extensions.

This traversal is not only time-consuming but also generates substantial network traffic, as multiple requests are required for each node. Additionally, the lack of uniformity in resource naming and URL structures means that the management application must be tailored to each specific implementation, which increases complexity and reduces scalability. For instance, an application designed to access the temperature sensor at /redfish/v1/Chassis/<ID>/Sensors/Temperatures/<ID> will fail to find the sensor if another server uses /redfish/v1/Chassis/Self/Sensors/101.

As a consequence of these variations in resource representation, naming conventions, and URL structures, users and management applications face significant challenges in accurately finding and accessing resources across heterogeneous data center environments without exhaustive knowledge of each implementation's specific schema.

In a second scheme, an intelligent search mechanism may collect and index all relevant resource information from the servers in the heterogeneous data center 202. This is achieved by deploying a URL mapping application, which systematically discovers all Redfish-capable nodes, such as the servers 222-1 to 222-M₁, 224-1 to 224-M², and 228-1 to 228-M_{K}. The URL mapping application performs a complete Redfish tree walk for each server, traversing from the root node to all accessible resources, and curates the gathered data.

During this data collection process, the URL mapping application cleans the curated data by stripping away non-essential metadata and standardizing the representation of resources. The cleaned data is then stored in a centralized, searchable database, such as an elastic search database or a similar document-oriented database. This database includes entries detailing the IP addresses of the servers, node types, BMC types, Redfish versions, traversed URLs, and the associated resource outputs.

By aggregating all this information into a unified database, the system provides a foundation for an efficient search mechanism. A query manager interfaced with the database allows users or applications to perform keyword-based searches or natural language queries to locate specific resources without needing prior knowledge of each implementation's schema or URL structures.

For example, a user can submit a query such as “Give me all the endpoints where there is an Intel NIC,” or “Sensor Name=‘CPUSensor1’.” The query manager processes these inputs using a query parser, which tokenizes and interprets the query terms. The system may employ natural language processing (NLP) techniques to handle more complex or conversational queries.

Once the query is parsed, the query manager constructs appropriate search queries for the database. It searches through the indexed data to find all instances that match the criteria, regardless of the original naming conventions or URL structures used by the different servers. The system then returns the relevant URLs, resource data, and associated server information to the user or requesting application.

This approach significantly reduces the number of network requests required to locate resources, as the search is performed on the centralized database rather than traversing each server's Redfish hierarchy individually. It also abstracts away the heterogeneity of the implementations, presenting a uniform interface to the user.

Furthermore, the system can dynamically update the database as new servers are added to the data center or existing servers are reconfigured. The Redfish data manager component monitors the data center for changes. The database remains current.

In this manner, the second technical scheme not only handles resource discovery and management in a heterogeneous data center environment but also enhances scalability and efficiency. It enables users to interact with their data centers more intuitively and effectively without needing in-depth knowledge of the underlying Redfish schemas or spending excessive time parsing through complex hierarchical structures.

In one example of the second technical scheme, as depicted in FIG. 2, the system employs a Redfish client 242, a cloud data collection entity 244, and a resource database 246 to address the challenges associated with heterogeneous Redfish API implementations in the data center 202. The Redfish client 242 interacts with the cloud data collection entity 244, submitting queries to obtain specific resource information without the need to navigate the complex hierarchical structures of each server's Redfish implementation.

The cloud data collection entity 244 serves as the central intelligence hub of the system, performing two primary functions: data collection and query processing. In the data collection phase, the cloud data collection entity 244 systematically discovers all Redfish-capable nodes within the heterogeneous data center 202. This includes traversing each of the racks 212-1, 212-2, . . . , 212-K and their respective servers—such as servers 222-1 to 222-M₁ in rack 212-1, servers 224-1 to 224-M₂ in rack 212-2, and servers 228-1 to 228-M_{K} in rack 212-K.

In certain configurations, the cloud data collection entity 244 may include a URL mapper. This mapper functions as an intelligent intermediary layer that maintains comprehensive information about each Redfish implementation deployed across the servers 222-1 to 222-M₁, 224-1 to 224-M₂, and 228-1 to 228-M_{K} within their respective racks 212-1, 212-2, . . . , 212-K.

The primary function of the URL mapper is to create and maintain a searchable corpus of resource locations and their associated metadata. This corpus serves as the foundation for implementing sophisticated search algorithms that can efficiently locate resources across the heterogeneous data center environment. The URL mapper achieves this by performing systematic discovery operations to identify all Redfish-capable nodes within the data center 202. During this discovery process, it traverses the complete Redfish tree structure of each server, documenting the hierarchical relationships between resources and their access paths.

Operating either as a cloud-hosted service or as an on-premise application, the URL mapper continuously monitors and updates the resource database 246. When it discovers a new Redfish-capable node, it initiates a comprehensive tree walk to gather detailed information about the node's resources, including their URLs, properties, and relationships. This information is then processed to strip away non-essential metadata while preserving the mapping between resource identifiers and their access paths.

The URL mapper's architecture supports dynamic updates to accommodate changes in the data center environment. As new servers are added or existing ones are modified, the mapper automatically detects these changes and updates its corpus accordingly. This dynamic nature of the URL mapper allows it to maintain an accurate and current representation of the data center's resource topology, enabling the cloud data collection entity 244 to provide precise and reliable responses to queries from the Redfish client 242.

Through its integration with the resource database 246, the URL mapper facilitates efficient search operations that can quickly locate resources based on various criteria, regardless of the specific naming conventions or URL structures used by different implementations. This capability significantly reduces the complexity of resource discovery and access in heterogeneous environments, where traditional methods would require extensive knowledge of each implementation's specific schema and URL patterns.

In general, for each server, the cloud data collection entity 244 initiates a comprehensive Redfish tree walk, starting from the root node and traversing through all accessible resources. During this traversal, it gathers resource data, including any OEM-specific extensions and proprietary naming conventions. The collected data captures the diverse ways in which resources are represented across different implementations, acknowledging variations such as temperature sensors named “CPU1Temp,” “TempSensor1,” or other equivalents.

After completing the data collection process, the cloud data collection entity 244 curates the gathered information. It cleanses the data by stripping away non-essential schema metadata and standardizes the representation of resources to create a uniform corpus. This involves normalizing resource names and consolidating similar resources under common identifiers. The curated data is then stored in the resource database 246.

The resource database 246 maintains a comprehensive mapping of resources within the data center 202. It includes entries detailing server IP addresses, node types, BMC types, Redfish versions, traversed URLs, and associated resource outputs. Implemented using an elastic search engine or a similar document-oriented database technology, the resource database 246 supports efficient indexing and search capabilities, facilitating rapid retrieval of information based on various search criteria.

When the Redfish client 242 seeks information about specific resources but is unaware of the exact URLs or naming conventions used across different implementations, it sends a query to the cloud data collection entity 244. For instance, the client might request, “Provide all temperature sensors in the data center,” or “Find all endpoints with an Intel NIC.” The cloud data collection entity 244 processes these queries using a query parser and a query manager.

The query parser interprets the incoming query, extracting relevant keywords and transforming them into searchable tokens. If the query is expressed in natural language, the system may employ natural language processing (NLP) techniques to understand the intent and context of the query. The query manager then constructs appropriate search queries for the resource database 246 based on the parsed tokens.

Using these queries, the resource database 246 is searched to locate all matching resources, irrespective of their original naming conventions or URL structures. The flexibility of the search mechanism allows the system to handle variations in resource representations seamlessly. For example, temperature sensors named differently across various servers are all identified and retrieved in response to the client's query.

The cloud data collection entity 244 compiles the search results, which include the relevant URLs, resource data, and associated server information, and returns them to the Redfish client 242. This enables the client to access the desired resources directly, without the need to traverse the hierarchical structures or adapt to different naming conventions and URL patterns.

The cloud data collection entity 244 operates dynamically, continually monitoring the data center 202 for changes. As new servers are added or existing servers are reconfigured, it performs updated Redfish tree walks to collect and curate the latest resource information.

By incorporating an elastic database or similar document-oriented database, the system provides easy access and search capabilities over the curated information. The centralized database becomes accessible for searches using refined Redfish queries, enabling clients to find the exact URLs and resource data they require without prior knowledge of each implementation's specific schema.

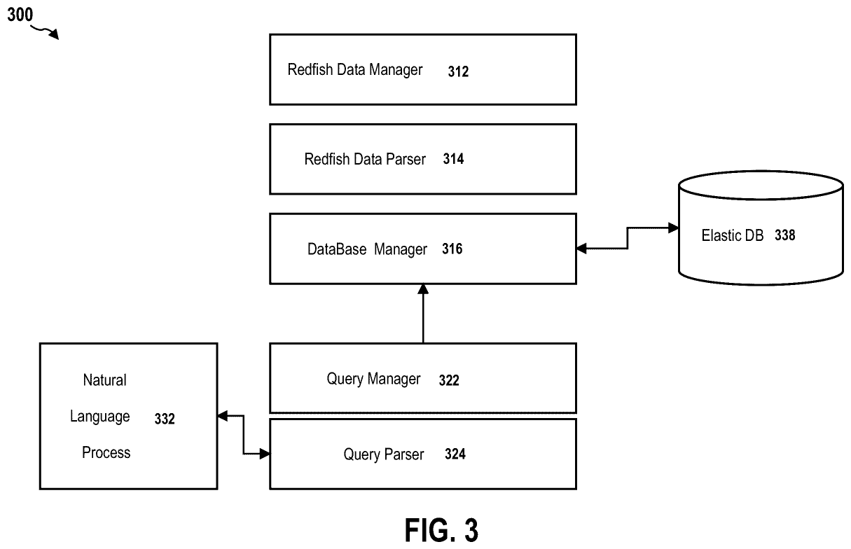

FIG. 3 is a block diagram 300 illustrating the key components and data flows in an intelligent URL mapping and search system designed to manage and curate information from heterogeneous Redfish API implementations in a data center environment. The system includes several interconnected modules that collaborate to collect, process, store, and retrieve resource information from Redfish-capable nodes within the data center. In particular, the system includes a Redfish data manager 312, a Redfish data parser 314, a database manager 316, a query manager 322, a query parser 324, a natural language process 332, and an elastic database 338. Each component may be implemented by one or more computing devices that have structures similar to that of the host computer 180.

Further, the system including the Redfish data manager 312, the Redfish data parser 314, the database manager 316, the query manager 322, the query parser 324, the natural language process 332, and the elastic database 338 may be implemented in various deployment configurations, including cloud-based, on-premises, or hybrid cloud setups. This flexibility allows the system to be integrated into different data center environments, accommodating varying requirements for scalability, security, and operational control.

In a cloud-based implementation, the core components of the system, such as the Redfish data manager 312 and the query manager 322, can be hosted on a cloud platform. The cloud data collection entity 244 may include the Redfish data manager 312, the Redfish data parser 314, the database manager 316, the query manager 322, the query parser 324, the natural language process 332. The cloud data collection entity 244 operates remotely, interacting with the servers in the heterogeneous data center 202 over a network. This setup utilizes the scalability and resource availability of cloud infrastructure to handle the data processing and storage demands. The resource database 246, implemented as the elastic database 338, can dynamically scale to accommodate the growing volume of curated data from the data center.

Alternatively, in an on-premises deployment, the entire system can be hosted within the data center's local infrastructure. The Redfish data manager 312, along with other components, runs on dedicated servers within the data center. This setup allows for greater control over data security and compliance, as sensitive resource information remains within the premises. The elastic database 338 is installed on local hardware, ensuring that data storage and retrieval operations are managed internally.

A hybrid cloud setup combines elements of both cloud-based and on-premises deployments. For instance, the data collection and parsing components, such as the Redfish data manager 312 and the Redfish data parser 314, can be deployed on-premises to collect and preprocess data locally. The processed data can then be securely transmitted to a cloud-hosted elastic database 338 for storage and advanced analytics. The query manager 322 and the natural language process 332 can be hosted in the cloud, providing powerful search and processing capabilities that benefit from cloud scalability. This configuration balances the need for local data control with the advantages of cloud-based services.

By supporting multiple deployment models, the system can meet the specific needs of various organizations. Data centers that prioritize rapid scalability and remote accessibility might opt for a cloud-based implementation, whereas those with strict data governance policies might prefer an on-premises setup. The hybrid model offers a middle ground, enabling efficient data processing and storage while maintaining certain operations locally.

The Redfish Data Manager 312 acts as the primary interface for discovering and collecting information from Redfish-capable nodes in the data center. The Redfish Data Manager 312 continuously monitors the data center for any newly enabled nodes. The system remains up-to-date with the current infrastructure. Upon detecting new nodes, the Redfish Data Manager 312 initiates a comprehensive discovery process, traversing each node's entire Redfish tree structure starting from the root node and accessing all available resources. This traversal follows the standard Redfish schema, utilizing RESTful APIs to navigate through the hierarchical resource structures of each node.

The data collected by the Redfish Data Manager 312 includes detailed information about the resources available on each node, such as sensors, processors, network interfaces, and any OEM-specific extensions. However, due to variations in naming conventions and resource representations across different implementations, the raw data may contain inconsistencies and non-essential metadata. To address this, the collected data is passed to the Redfish Data Parser 314.

The Redfish Data Parser 314 is responsible for preprocessing and normalizing the raw Redfish responses. It strips away non-essential metadata, such as unnecessary schema annotations or implementation-specific details, while preserving the core resource information and access paths. The parser focuses on identifying key resource attributes and standardizing their representation to enable efficient search and retrieval. For example, when processing temperature sensor data that may be named differently across implementations (e.g., “CPU1Temp”, “TempSensor1”, “temp1”), the Redfish Data Parser 314 normalizes these names to a standard form or associates them with common identifiers.

The cleaned and standardized data is then transformed into consumable JSON documents that adhere to a consistent format. Despite the heterogeneity in the original data, the processed information can be uniformly stored and accessed. The processed data is handed over to the Database Manager 316 for storage and indexing.

The Database Manager 316 interfaces with the Elastic Database 338, which serves as the primary storage system for the curated resource information. The Elastic Database 338 is a document-oriented database chosen for its efficient storage, indexing, and search capabilities, particularly suited for handling large volumes of semi-structured data. The Database Manager 316 stores metadata in the Elastic Database 338, including server IP addresses, node types, BMC types, Redfish versions, traversed URLs, and associated resource outputs.

When users or applications need to locate specific resources within the data center, they interact with the system through the Query Parser 324 and the Query Manager 322. The Query Parser 324 is responsible for processing incoming search requests, which may be in the form of structured API calls or natural language queries. For instance, a user might submit a query such as “Give me all temperature sensors in the data center.” The Query Parser 324 parses the query, extracting relevant keywords and transforming them into a set of searchable tokens.

In cases where the query is expressed in natural language, the system uses the natural language process 332 to enhance the understanding of the query's intent and context. The natural language process 332 employs advanced NLP techniques or AI models—potentially third-party systems or custom-trained models—to interpret complex queries, handle variations in phrasing, and disambiguate terms. This component is particularly useful when dealing with OEM-specific extensions, where resource names and structures may deviate from standard patterns.

The Query Manager 322 takes the processed tokens from the Query Parser 324 and constructs appropriate database queries that can be executed against the Elastic Database 338. It employs various search strategies, including regular expression (regex) pattern matching for standard schema elements, wildcard searches, and semantic matching for handling synonyms or related terms. The Query Manager 322 interfaces with the Database Manager 316 to execute these queries efficiently.

Once the search is performed, the Query Manager 322 retrieves the relevant resource information from the Elastic Database 338. This information includes not only the matching resource URLs but also associated metadata such as the server IP addresses, resource properties, and any additional data required by the user or application. The Query Manager 322 compiles the results into a response that is returned to the requester.

In one example, the Redfish Data Manager 312 can continuously update the database as changes occur in the data center, such as the addition of new nodes or the reconfiguration of existing ones. Similarly, the natural language process 332 can be improved or replaced without affecting the core data storage and retrieval mechanisms.

In operation, when an external Redfish client or user submits a query, the system abstracts away the complexities associated with the heterogeneous implementations of the Redfish API across different servers. Users can discover resources using intuitive queries without needing explicit knowledge of each server's specific schema or URL structures. This approach greatly simplifies resource management in large-scale, heterogeneous data centers. By normalizing data and employing intelligent query processing, the system can handle discrepancies in resource naming and representation.

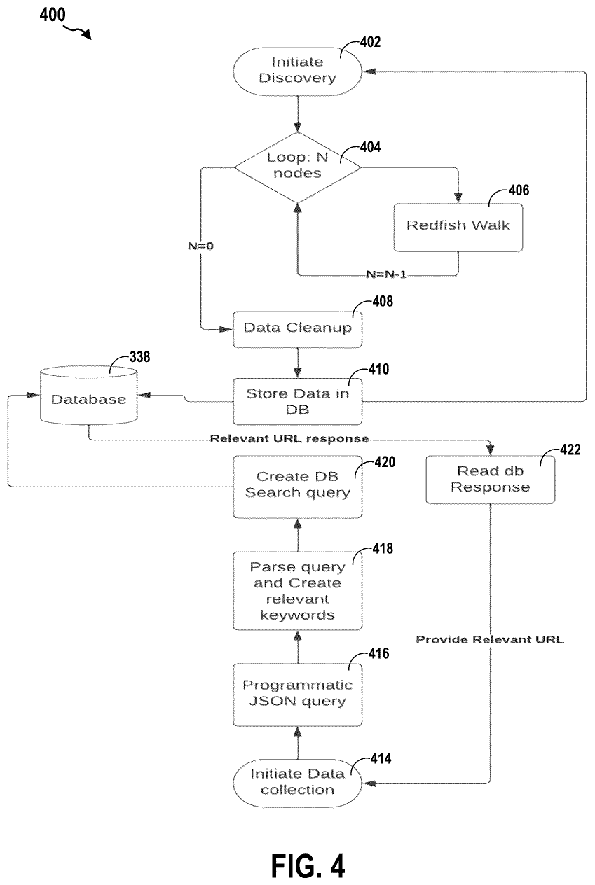

FIG. 4 is a flowchart 400 illustrating a process for discovering, collecting, and managing resource information in a heterogeneous data center environment using an intelligent URL mapping system. The process comprises two main workflows: a data collection and storage workflow, and a query processing workflow.

In the data collection workflow, the process begins at operation 402 where the system initiates discovery of Redfish-capable nodes in the heterogeneous data center 202. At operation 404, the system enters a loop that processes N nodes, where N represents the total number of nodes to be discovered across the racks 212-1, 212-2, . . . , 212-K. For each node in the loop, operation 406 performs a Redfish walk, systematically traversing the Redfish tree structure to collect resource information. The loop decrements N by 1 (N=N−1) after processing each node and continues until all nodes (N=0) have been processed.

Once the loop completes, the process moves to operation 408, where the Redfish data parser 314 performs data cleanup on the collected information. This cleanup involves removing non-essential metadata and standardizing the resource representations. At operation 410, the database manager 316 stores the cleaned data in the elastic database 338. The system then enters a waiting state for new node discovery, creating a continuous monitoring cycle that returns to operation 402 when new nodes are detected.

The query processing workflow begins at operation 414 when a Redfish client 242 initiates a data collection request. At operation 416, the system creates a programmatic JSON query based on the client's request. The query parser 324 then processes this query at operation 418, parsing it and creating relevant keywords. These keywords may be derived from natural language inputs processed by the natural language process 332. At operation 420, the query manager 322 creates appropriate database search queries for the elastic database 338.

The elastic database 338 processes these queries and provides relevant URL responses, which are read at operation 422. The system then provides the relevant URLs, along with associated node IPs and resource information, back to the initiating data collection request at operation 414. This creates a continuous cycle of query processing and response delivery.

This dual-workflow architecture enables efficient resource discovery and access in heterogeneous environments where different servers may implement varying naming conventions and URL structures for similar resources. For example, when searching for temperature sensors, the system can locate and return information about sensors named “CPU1Temp” in some servers and “TempSensor1” in others, abstracting away these implementation differences from the requesting client.

The process supports dynamic updates to the resource database 246 as the data center environment changes, while providing a unified interface for resource discovery and access. Through this approach, the system addresses the challenges of managing heterogeneous Redfish API implementations by maintaining an up-to-date, searchable corpus of resource information that can be accessed through intuitive queries

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of operation of a computing device, comprising:
initiating discovery of Redfish-capable node devices in a data center by transmitting RESTful API requests to network addresses within the data center to identify the Redfish-capable node devices;
performing a Redfish tree walk for each discovered node device to collect resource information by traversing a hierarchical Redfish schema structure through RESTful API calls starting from a root endpoint of the each discovered node device;
parsing the collected resource information to generate cleaned data by removing non-essential data, standardizing resource naming conventions across different implementations, and converting the resource information into consumable documents;
storing the cleaned data in a database; and
providing a query interface for accessing resources across the data center using keyword-based searches.

2. The method of claim 1, wherein performing the Redfish tree walk comprises:
collecting resource data including uniform resource locators (URLs) and associated resource properties.

3. (canceled)

4. The method of claim 1, further comprising:
receiving a search query from a client;
parsing the search query to extract keywords;
generating a database search query based on the extracted keywords; and
returning relevant URLs and associated resource information matching the search query.

5. The method of claim 4, wherein parsing the search query comprises:
processing natural language input using a natural language processor; and
generating searchable tokens based on the processed natural language input.

6. The method of claim 1, further comprising:
monitoring the data center for newly enabled nodes; and
automatically initiating discovery and data collection for the newly enabled nodes.

7. The method of claim 1, wherein storing the cleaned data comprises:
indexing the cleaned data in an elastic database; and
maintaining associations between resource identifiers and corresponding access paths.

8. The method of claim 1, further comprising:
receiving a resource request from a Redfish client;
creating a programmatic JSON query based on the resource request;
parsing the programmatic JSON query to generate search keywords; and
retrieving relevant resource information from the database based on the search keywords.

9. The method of claim 8, wherein retrieving relevant resource information comprises:
identifying matching resources across different implementations regardless of varying naming conventions; and
returning unified resource information including URLs and server identification data.

10. The method of claim 1, wherein providing the query interface comprises:
supporting keyword-based searches for resources across heterogeneous Redfish implementations;
abstracting implementation-specific details from search results; and
returning standardized resource information to requesting clients.

11. The method of claim 1, further comprising:
detecting variations in resource naming conventions across different server implementations;
normalizing the variations into standardized identifiers; and
maintaining mappings between standardized identifiers and implementation-specific names.

12. The method of claim 1, wherein storing the cleaned data comprises:
organizing resource information by server IP addresses, node types, baseboard management controller (BMC) types, and Redfish versions; and
maintaining relationships between resources and their access paths.

13. The method of claim 1, further comprising:
processing original equipment manufacturer (OEM)-specific extensions in the collected resource information;
identifying common resources across different OEM implementations; and
creating unified resource representations while preserving OEM-specific details.

14. The method of claim 1, wherein providing the query interface comprises:
supporting natural language queries for resource discovery;
translating natural language queries into database search criteria; and
returning relevant resource information matching the search criteria.

15. The method of claim 1, further comprising:
maintaining a continuous monitoring cycle for data center changes;
updating the database with new resource information; and
providing real-time access to current resource data through the query interface.

16. An apparatus, comprising:
a memory; and
at least one processor coupled to the memory and configured to:
initiate discovery of Redfish-capable node devices in a data center by transmitting RESTful API requests to network addresses within the data center to identify the Redfish-capable node devices;
perform a Redfish tree walk for each discovered node device to collect resource information by traversing a hierarchical Redfish schema structure through RESTful API calls starting from a root endpoint of the each discovered node device;
parse the collected resource information to generate cleaned data by removing non-essential data, standardizing resource naming conventions across different implementations, and converting the resource information into consumable documents;
store the cleaned data in a database; and
provide a query interface for accessing resources across the data center using keyword-based searches.

17. The apparatus of claim 16, wherein to perform the Redfish tree walk, the at least one processor is further configured to:
collect resource data including uniform resource locators (URLs) and associated resource properties.

18. (canceled)

19. The apparatus of claim 16, wherein the at least one processor is further configured to:
receive a search query from a client;
parse the search query to extract keywords;
generate a database search query based on the extracted keywords; and
return relevant URLs and associated resource information matching the search query.

20. A non-transitory computer-readable medium storing computer executable code for operating a computing device, comprising code to:
initiate discovery of Redfish-capable node devices in a data center by transmitting RESTful API requests to network addresses within the data center to identify the Redfish-capable node devices;
perform a Redfish tree walk for each discovered node device to collect resource information by traversing a hierarchical Redfish schema structure through RESTful API calls starting from a root endpoint of the each discovered node device;
parse the collected resource information to generate cleaned data by removing non-essential data, standardizing resource naming conventions across different implementations, and converting the resource information into consumable documents;
store the cleaned data in a database; and
provide a query interface for accessing resources across the data center using keyword-based searches.
